(19) United States
(12) Patent Application Publication
(10) Pub. No.: US 2011/0093312 A1
(43) Pub. Date: Apr. 21, 2011

(54) MODELING WHOLESALE PRICE SCHEDULES TO REDUCE DOUBLE MARGINALIZATION

(76) Inventors: Julie Ward Drew, Redwood City, CA (US); Jose Luis Beltran Guerrero, Palo Alto, CA (US); Guillermo Gallego, Waldwick, NJ (US); Ming Hu, Toronto (CA); Shailendra K. Jain, Cupertino, CA (US)

(21) Appl. No.: 12/581,840

(22) Filed: Oct. 19, 2009

(51) Int. Cl. G06Q 10/00; G06Q 50/00

(52) U.S. Cl. 705/7.35; 705/400

(57) ABSTRACT

One embodiment is a method that determines, for a sale of a product and a post-sale service for the product from a supplier to a retailer, an expected supply chain profit for the sale as a function of an effort cost function of the retailer, a quantity of the product ordered, and an expected revenue of the retailer. A wholesale price schedule is determined that is a function of the quantity of the product ordered by the retailer. The wholesale price schedule reduces effects of double marginalization on the sale of the product and the post-sale service.

### BACKGROUND

Multi-tier supply chains suffer from a problem known as double marginalization. Double marginalization occurs when a supplier and retailer both markup the cost of a product above its marginal cost. The consumer purchasing the product therefore pays for two (double) markup costs. This problem arises because a manufacturer and its channel partners (such as retailers) all want to extract margins from the sale of a product in order to make it worthwhile for them to participate.

With double marginalization, downstream channel members like retailers will not exert as much sales effort toward selling a product as they would if they were not sharing the margin with upstream channel members. Double marginalization also produces higher retail prices and lower combined profits for the supply chain when compared with supply chains that are vertically integrated.

Since product margins on many products are quite narrow, many suppliers and retailers use post-sale services (such as extended warranties) to increase profitability associated with the sale of a product. The prospect of selling the high-margin service provides retailers incentive to exert more effort to sell the product in order to create more service attach opportunities:

### BRIEF DESCRIPTION OF THE DRAWINGS

FIG. 1 is a diagram of a supply chain in accordance with an example embodiment of the present invention.

FIG. 2 is a diagram of system that exchanges product and service terms between a supplier and a retailer and provides a service agreement to customers in accordance with an example embodiment of the present invention.

FIG. 3 is a flow diagram of a method for calculating the product and service terms between the supplier and the retailer and providing the service agreement to the customers in accordance with an example embodiment of the present invention.

FIG. 4 is a flow diagram of a method for selling a product and associated service to a customer in accordance with an example embodiment of the present invention.

FIG. 5 is a flow diagram of a method for determining wholesale price schedule contract parameters in accordance with an example embodiment of the present invention.

FIG. 6A is a flow diagram of a method for building a model of expected profits of supply chain members in accordance with an example embodiment of the present invention.

FIG. 6B is a computer for building the model of FIG. 6A in accordance with an example embodiment of the present invention.

FIG. 7 is a flow diagram of a method for applying the model to determine parameters for a wholesale price contract in accordance with an example embodiment of the present invention.

FIG. 8 shows a computer system for implementing processes in accordance with an example embodiment of the present invention.

### DETAILED DESCRIPTION

Example embodiments relate to apparatus, systems, and methods that determine parameters for a wholesale price contract or schedule between a supplier and a retailer.

One embodiment generates a wholesale price schedule on the sale of a product and a post-sale service for a supplier to offer to a retailer or other downstream channel member. In the wholesale price schedule, the supplier sells the service to the retailer for no profit (i.e., at cost) and leaves profit from the sale of the service to the retailer.

As used herein and in the claims; the term “post-sale service” is a service associated with a product and provided after the sale of the product. An example of a post-sale service is an extended warranty sold with the sale of a product.

As used herein and in the claims, the term “channel member” is an entity which re-sells goods and services provided by one or more suppliers to customers. Examples of a channel member include retailers or distributors.

Example embodiments also include a method of determining the parameters of the wholesale price schedule that will reduce the effects of double marginalization on the sale of the product and the post-sale service.

As used herein and in the claims, the term “double marginalization” is when a supplier and retailer both markup the cost of a product above its marginal cost. The consumer purchasing the product therefore pays for two (double) markup costs. Double marginalization arises because a manufacturer and its channel partners (such as retailers) all want to extract margins from the sale of a product in order to make it worthwhile for them to participate.

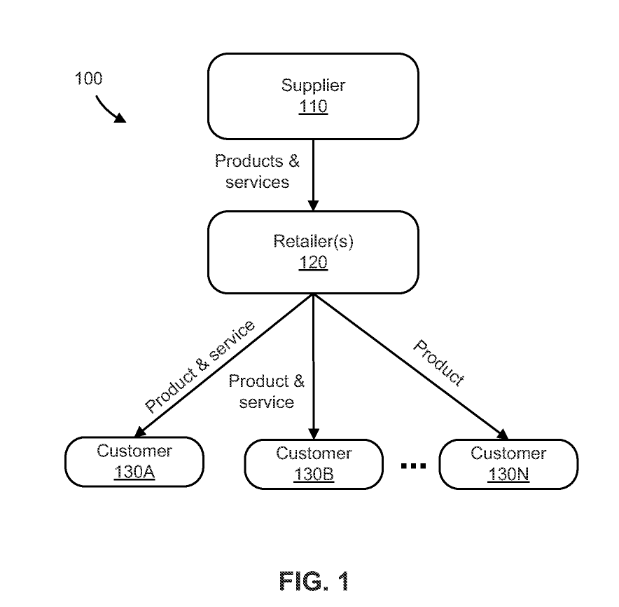

FIG. 1 is a diagram of a supply chain 100 that includes a supplier 110 providing and/or selling products and services to one or more retailers 120. The retailers, in turn, sell the products and services to customers (shown as customer 130A, 130B, to 130N). Some customers buy both the product and service (such as customers 130A and 130B), and other customers purchase the product without the service (such as customer 130C).

In the supply chain 100, the supplier 110, such as an original equipment manufacturer (OEM), sells both a product and an ancillary service to the customers 130A-130N through the retailer 120. Example embodiments include a wide variety of products that include, but are not limited to, personal computing devices (such as notebook, desktop, and tablet computers), servers, storage devices, printers and other imaging devices, electronic test equipment and systems, medical electronic equipment, solid state components and instrumentation, and other electrical and non-electrical devices.

Demands for both the product and the service are influenced by sales efforts of the retailer. Example embodiments provide incentives through channel coordination that the supplier 100 offers to the retailer 120 to incentivize the retailer to increase efforts in selling both the product and its ancillary service.

As used herein and in the claims, the term “channel coordination” refers to the state when the supply chain members' optimal decisions lead to equivalent total supply chain profits as would be achieved if decisions were made by a single, centralized decision maker. For example, in the context of this invention, channel coordination means that the retailer's optimal choice of order quantity and sales effort is equivalent as he would choose if the supplier provided the goods and services to the retailer at cost, without any supplier markup.

These increased efforts through channel coordination include, but are not limited to, providing more employees or man-hours to sell a product, spending more money on promotions or advertisement, providing employees with incentives to sell the product, providing product training, discounts, etc. To achieve channel coordination and share the gains of this coordination, example embodiments use a wholesale price schedule for the product and the service. The wholesale price schedule is an integrated solution that reduces the effects of double marginalization for both the product and the service.

In one example embodiment, a supply chain coordination scheme is provided such that the retailer receives rebates when a quantity of product ordered and a quantity of service attached to the product exceed respective thresholds. These rebates work with any given wholesale prices and can be separately executed, for example, by the supplier's production and service departments. Example embodiments also include instances wherein profits are higher if the retailer instead of the supplier provides the service to the customer.

In order to assist in a further discussion of example embodiments, the description is divided with various headings below.

Overview

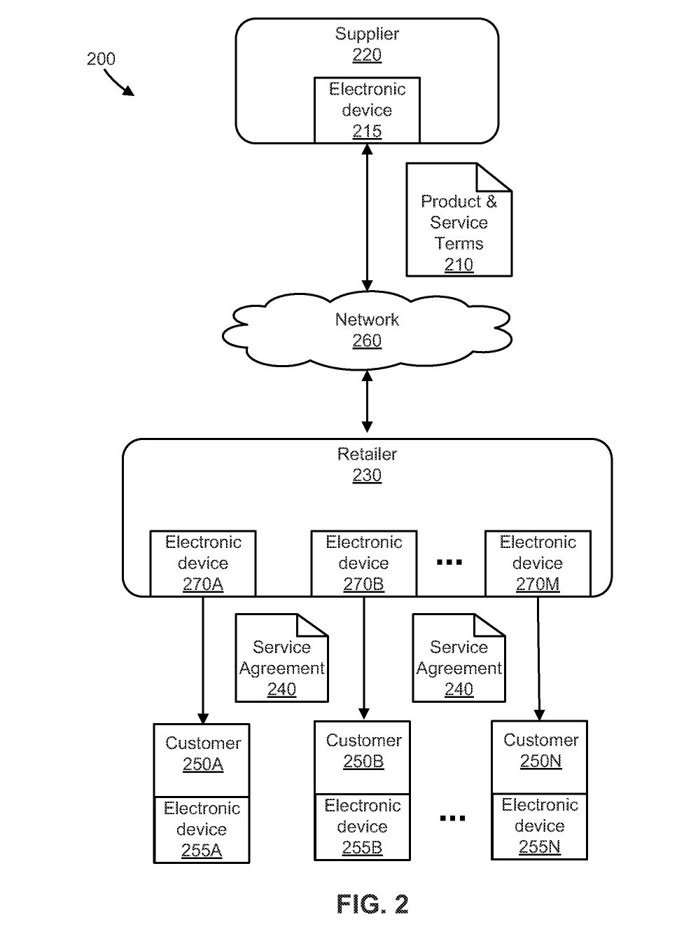

FIG. 2 is a diagram of system 200 that exchanges product and service terms 210 between a supplier 220 and a retailer 230. These terms includes a service agreement 240 that is provided to customers (shown as customer 250A, 250B, to 250N) with the sale of a product to the customer. By way of example, the product and service terms 210 can be electronically exchanged from an electronic device 215 at the supplier 220 to electronic devices 270A, 270B, . . . , 270M of the retailer 230. The service agreements 240 can also be exchanged from the electronic devices 270A-270M of the retailer to electronic devices 255A, 255B, . . . , 255N. Although FIG. 2 shows the product and service terms 210 and service agreement 240 being electronically transmitted, these can also be transmitted and/or exchanged in person.

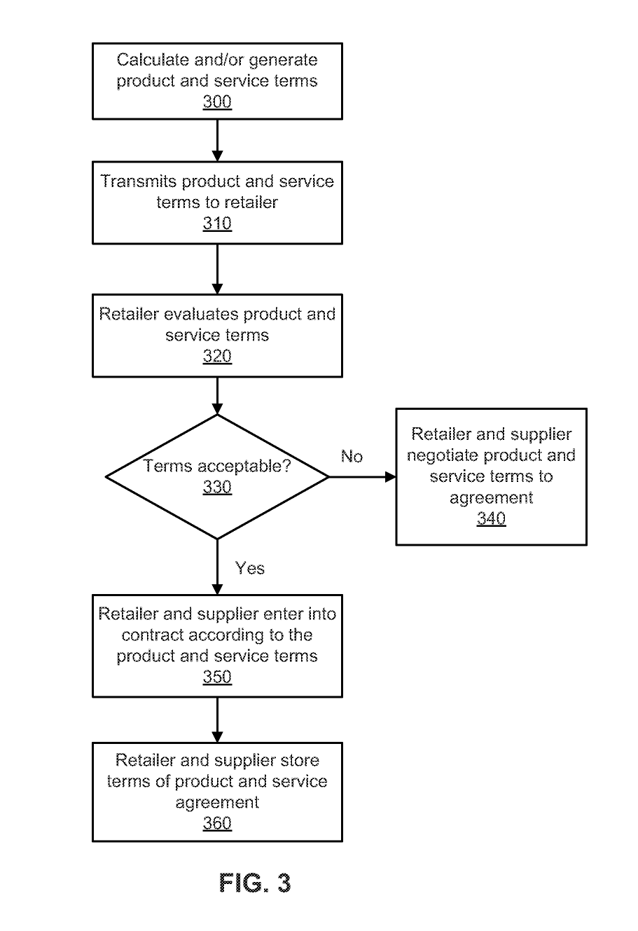

FIG. 3 is a flow diagram of a method for calculating the product and service terms 210 between the supplier 220 and the retailer 230 and providing the service agreement 240 to the customers 250A-250N.

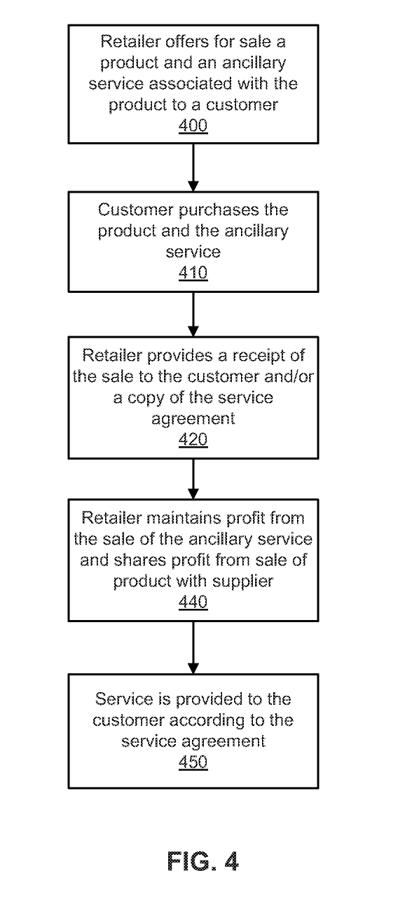

FIG. 4 is a flow diagram of a method for selling a product and associated service to the customer 250A-250N.

One or more of the blocks described in FIGS. 3 and 4 can be implemented in hardware, software, firmware, and/or modules associated therewith.

According to block 300 product and service terms are calculated and/or generated for the sale of products and associated or ancillary services to the retailer and customers. Calculation and analysis of these terms are more fully discussed below beginning with the section entitled “Example Model”.

According to block 310, the product and service terms are transmitted to the retailer. For example, the supplier 220 calculates the product and service terms 210 and transmits these terms through a network 260 (such as the internet) to the retailer 230.

According to block 320, the retailer evaluates the product and service terms. For example, the retailer considers terms and conditions that relate to a wholesale price schedule, rebates, price of goods, terms of services offered to the customer, etc. The retailer can also calculate and/or modify the terms and conditions and transmit them to the supplier.

If the terms are not acceptable, then flow proceeds back to block 340. Here, the supplier 220 and the retailer 230 negotiate terms and conditions for the sale of products and ancillary services to reach an agreement. For example, the retailer 230 transmits the product and service terms or modifications thereof back through the network 260 to the supplier 220. The supplier transmits acceptance and/or modifications back to the retailer until an agreement is reached.

If the terms are acceptable, then flow proceeds to block 350 where the retailer and supplier enter into a contract according to the product and service terms.

According to block 360, once an agreement on these terms and conditions is met, the parties electronically store these terms and conditions, such as storing them in memory, a database, etc.

Looking now to FIG. 4, according to block 400, a retailer offers for sale a product and an ancillary service associated with the product (for example, a warranty or service agreement for the product) to a customer.

According to block 410, the customer purchases the product and the ancillary service. For example, the customer purchases the product and service from a retail or online store of the retailer. Alternatively, the customer purchases the product without the ancillary service.

According to block 420, the retailer provides a receipt of the sale of the product and a copy of the service agreement to the customer. The service agreement is provided to the customer with the sale of a product. The receipt and/or service agreement can be provided to the customer in a variety of ways including, but not limited to, printing, emailing, texting, mailing, displaying, etc.

The terms and conditions negotiated between the supplier and the retailer include a service agreement that accompanies the sale of a product to a customer. For example, the service agreement 240 is accessed from one or more electronic devices (shown as electronic device 270A, electronic device 270B, to electronic device 270M) at the retailer 230 during the purchase of a product by a customer 250A-250N. The electronic devices 270A-270M include, but are not limited to, electronic cash registers, scanners, portable or handheld computing devices, and computers. Alternatively, the service agreement is exchanged, transmitted, and/or signed in person.

The service agreement 240 includes post-sale services that are provided to the customer 250A-250N. Extended warranties are one example of a vast range of post-sales services sold by retailers and suppliers. Others services include, but are not limited to, contracts, in-home installation, data backup services, accidental damage protection, theft protection, financing, insurance, and in-store product “optimizations”.

According to block 440, the retailer maintains profit from the sale of the ancillary service and shares profit from the sale of the product with the supplier. The profit sharing occurs through the wholesale prices paid by the retailer to the supplier for the product. In other words, the retailer “shares profit” by paying the wholesale prices dictated by price schedule. Profit sharing is a byproduct of the design of the wholesale prices in the price schedule.

According to block 450, the service is provided to the customer according to the service agreement. In one embodiment, the supplier provides or performs the service to the customer. Alternatively, the retailer provides or performs the service to the customer.

Since product margins are often small, retailers and suppliers use post-sales services (such as extended warranties) to increase profits associated with the sale of a product. In addition to higher profits, post-sales services help suppliers and retailers maintain a connection with their customers. This connection can lead to up-selling opportunities and higher customer loyalty. Furthermore, post-sales services extend the useful life of products, which can drive higher sales of consumables. Additionally, services are often more easily differentiated than commodity products and thus provide a way for retailers and suppliers to set themselves apart from competition.

The product and service terms 210 are designed to coordinate the supply chain and arbitrarily divide the benefits of coordination between the supplier 220 and retailer 230. For example, the product and service terms include a wholesale price schedule contract that achieves supply chain coordination and is beneficial to both the supplier and retailer.

According to the wholesale price schedule for services, the supplier 220 sells a service to the retailer 230 at cost (i.e., at cost to the supplier) and thus leaves all of the profits from the sales of services to the retailer. These services are then provided by the supplier to the customer 250A-250N and tied to the sale of the product through the service agreement 240.

In one embodiment, the wholesale price schedule for the basic product is decreasing in the order quantity and is higher than it would be without the sales of services. For example, the wholesale price schedule for the basic product arbitrarily splits the gains from coordination resulting in a win-win contract for both the supplier and the retailer. In other words, the wholesale price schedule for the basic product has embedded in the schedule a share of the profit from selling services that goes to the supplier and provides additional profits to both the supplier and the retailer.

In one embodiment, the supplier chooses what percentage of the supply chain profits will be give to the supplier versus the retailer when designing the parameters of the wholesale price schedule. The supplier chooses the parameters in such a way that the resulting profits are large enough that both parties are willing to participate.

This schedule forms a barrier to entry as the retailer has less of an incentive to compete by offering its own services. This is particularly true if the supplier enjoys economies of scale in the overall cost of providing the ancillary service.

The wholesale price contract coordinates the supply chain and requires cooperation between product and service divisions of the supplier. A second embodiment is implemented in the form of a target rebate schedule starting from arbitrary constant wholesale prices for both the basic product and the service. The rebate schedule is on the quantity ordered, not on the actual sales realized by the retailer, and on the realized attach rate for services. As discussed below, alternative coordinating mechanisms exist as well, such as charging a premium for hardware sold with attached services.

Example embodiments also include a situation where the retailer instead of the supplier provides the ancillary service. Assuming that the retailer can provide the service at the same price and at the same cost as the supplier, the wholesale price schedule that coordinates the supply chain is of a similar form as when the supplier provides the service. One difference is that the range of the profit sharing parameter is shifted in the favor of the retailer (i.e., the retailer receives a larger percentage of the profit than the supplier for the sale of the product). Even so, it is often possible to find a win-win profit sharing parameter that makes the supplier better off relative to providing the ancillary service in an uncoordinated setting. Moreover, in an uncoordinated setting, supply chain profits are higher leading to a higher supply chain efficiency than when the supplier provides the service. This increase occurs because ownership by the retailer avoids the double marginalization problem with regard to the ancillary service.

Some example embodiments are explained below in a setting where retail prices are assumed exogenous, and the retailer controls the product order quantity and sales effort exerted for both the product and its ancillary service. For example, the retailer controls an amount of money spent in advertising, promoting, and selling the product and the post-sale service even when the supplier provides the post-sale service to the customer who purchased the product and the post-sale service. An extension of the basic model is provided in which the retailer also controls the retail prices of the service and product. Channel coordinating wholesale price contracts in this setting can arbitrarily divide the benefits of coordination. One of the coordinating schedules that is dependent on the order quantity and posted retail price is viewed as a combination of a quantity discount contract and price-discount sharing scheme.

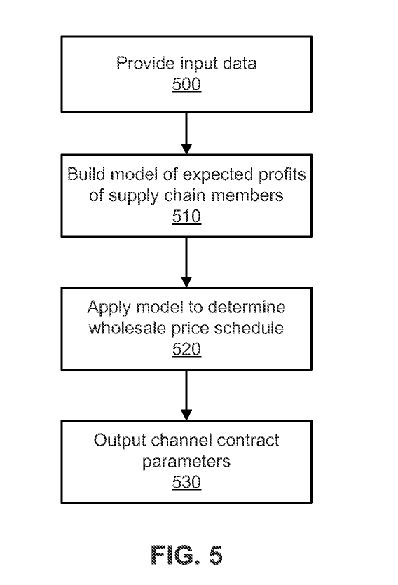

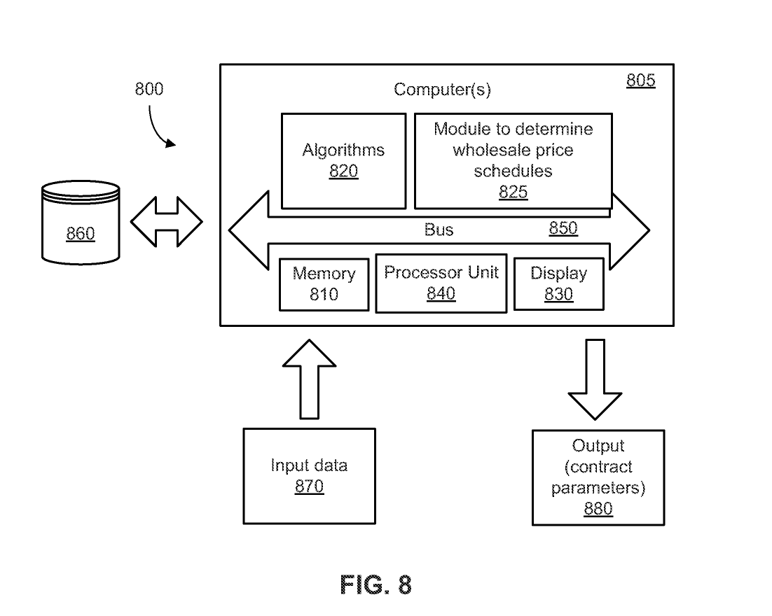

FIG. 5 is a method for determining wholesale price schedule contract parameters. The method can be executed by the computer system 800 shown in FIG. 8.

As used herein and in the claims, the term “contract parameters” refers to the mathematical expressions that describe the wholesale price for the service, and the wholesale price schedule w(Q) for the basic product as a function of retailer order quantity Q.

According to block 500, data is input, received, obtained, or generated. For example as shown in FIG. 8, the data 870 is input into computer 805.

By way of example, this data includes, but is not limited to, one or more of supplier's unit costs c, cₛ for basic product and service, retail prices p, pₛ for basic product and service, salvage value s for basic product, distribution F(x|ν) of customer demand for basic product as function of sales effort parameter ν, retailer's cost of sales effort k(ν) for the basic product as function of parameter ν, retailer's cost v(a) for service attach rate a, and desired proportion γ of profits to go to retailer.

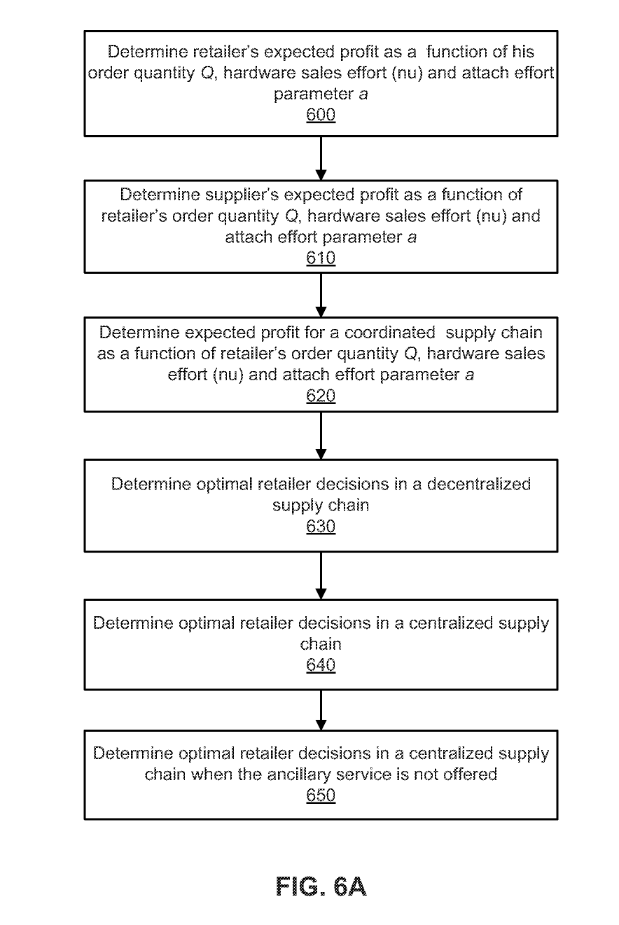

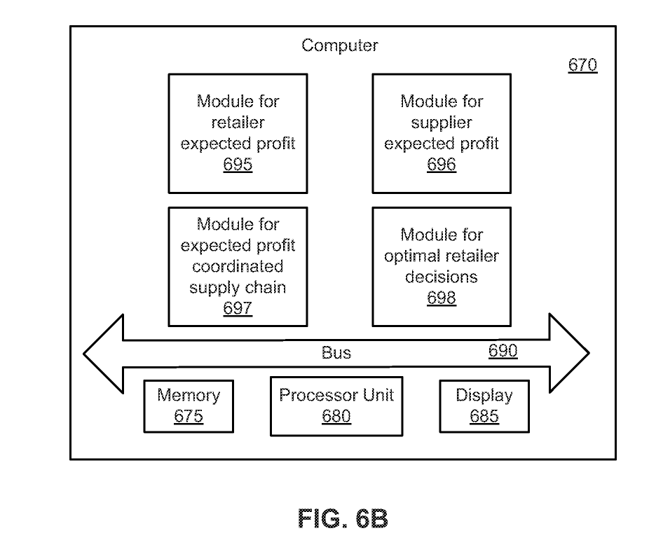

According to block 510, a model of expected profits of supply chain member is built. This model is more fully explained in connection with FIGS. 6A and 6B.

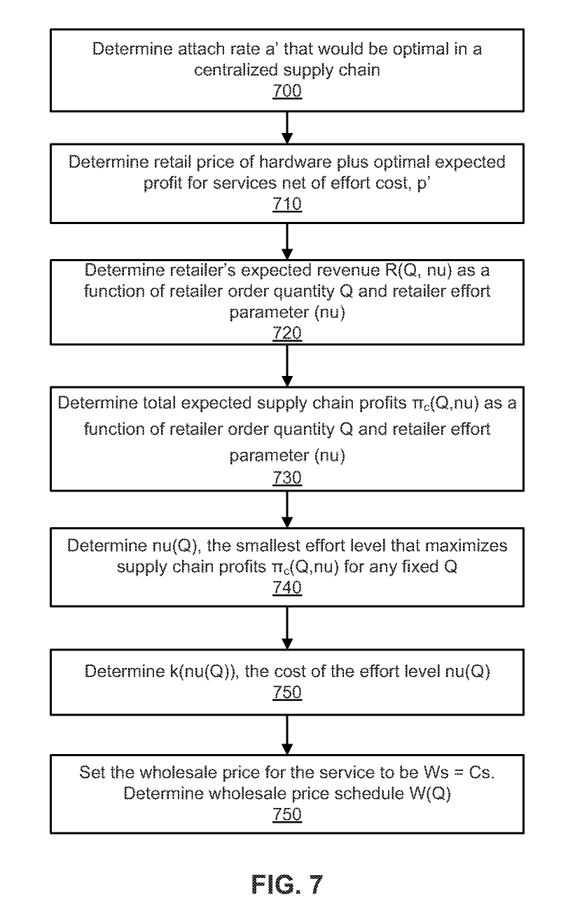

According to block 520, the model is applied to determine a wholesale price scheduled. This block is more fully explained in connection with FIG. 7.

According to block 530, channel contract parameters are output. For example as shown in FIG. 8, output contract parameters 880 are output from computer 805.

FIG. 6A is a flow diagram of a method for building a model of expected profits of supply chain members in accordance with an example embodiment of the present invention. FIG. 6B is a computer for building the model of FIG. 6A in accordance with an example embodiment of the present invention. These figures are discussed together.

By way of example, the computer 670 includes memory 675, a processing unit 680, a display 685, and various models 695-698 coupled with one or more connections or buses 690. The processor unit includes a processor (such as a central processing unit, CPU, microprocessor, application-specific integrated circuit (ASIC), etc.) for controlling the overall operation of memory 675 (such as random access memory (RAM) for temporary data storage, read only memory (ROM) for permanent data storage, and firmware). The processing unit 680 communicates with memory 675 and modules 696-698 to perform operations and tasks necessary for building a model of expected profits for supply chain members. The memory 675, for example, stores applications, data, programs, algorithms or modules (including software to implement or assist in implementing embodiments in accordance with the present invention) and other data.

The computer system includes one or more databases or warehouses 660 coupled to one or more computers or servers 605.

According to block 600, a determination is made of a retailer's expected profit as a function of his order quantity Q, hardware sales effort ν (labeled as “nu” in FIGS. 6 and 7), and attach effort parameter a. As discussed more fully below in the section Example Model, this step includes model elements of:

π_{R}(Q,ν,a|w,r)=−k(ν)−(w−s)Q+(p+ra−v(a)−s)Emin(Q,D_{ν}).

By way of example, this step is performed with the module for retailer expected profit 695.

According to block 610, a determination is made of the supplier's expected profit as a function of retailer's order quantity Q, hardware sales effort ν and attach effort parameter a. As discussed more fully below in the section Example Model, this step includes model elements of:

π_{S}(Q, ν,a|w,r)=(w−c)Q+(r′−r)a Emin(Q,D_{ν}), where r′=pₛ−cₛ.

By way of example, this step is performed with the module for supplier expected profit 696.

According to block 620, a determination is made of the expected profit for a coordinated supply chain as a function of retailer's order quantity Q, hardware sales effort ν and attach effort parameter a. As discussed more fully below in the section Example Model, this step includes model elements of:

π_{C}(Q,ν,a)=π_{R}(Q,ν,a|c,r′).

By way of example, this step is performed with the module for expected profit coordinated supply chain 697.

According to block 630, a determination is made of the optimal retailer decisions in a decentralized supply chain. As discussed more fully below in the section Example Model, this step includes model elements of:

Optimal attach rate a(r) is solution to v′(a)=r. Optimal order quantity Q_{R}(w, r) and sales effort ν_{R}(w, r) satisfy: F(Q|ν)=[p−w+r a(r)−v(a(r))]/[p−s+r a(r)−v(a(r))] k′(ν)=(p+r a(r)−v(a(r))−s) [δEmin(Q, D_{ν})/δν].

By way of example, this step is performed with a module for optimal retailer decisions 698.

As used herein and in the claims, a “decentralized supply chain” is a supply chain in which decisions within the control of each individual supply chain member are made by that supply chain member to optimize their own profits, rather than by a single centralized decision maker.

As used herein and in the claims, the terms “optimal” or “optimum” or “optimize” describe a most desirable solution given a restriction. The solution minimizes a cost function, such as providing most efficient or best solution with regards to cost, time, space, or number.

According to block 640, a determination is made of the optimal retailer decisions in a centralized supply chain. As discussed more fully below in the section Example Model, this step includes model elements of:

Optimal attach rate is a(r′), the solution to v′(a)=r′. Optimal order quantity Q_{C} and sales effort level ν_{C} are given by Q_{C}=Q_{R}(c, r′) and ν_{C}=ν_{R}(c, r′).

By way of example, this step is performed with a module for optimal retailer decisions 698.

As used herein and in the claims, a “centralized supply chain” is a supply chain in which all decisions are made by a single, centralized decision maker to maximize overall supply chain profits.

According to block 650, a determination is made of the retailer decision in a centralized supply chain when the ancillary service is not offered. As discussed more fully below in the section Example Model, this step includes model elements of:

Q₀=Q_{R}(w, 0) and ν₀=ν_{R}(w, 0).

By way of example, this step is performed with a module for optimal retailer decisions 698.

FIG. 7 is a flow diagram of a method for applying the model to determine parameters for a wholesale price contract in accordance with an example embodiment of the present invention. By way of example, steps in this method are performed with modules to determine a wholesale price schedule 825 shown in FIG. 8.

According to block 700, a determination is made of an attach rate a′ that would be optimal in a centralized supply chain. As discussed more fully below in the section Example Model, this step includes model elements of:

Let r′=pₛ−cₛ. Then a′=a(r′), the root of equation v′(a)=r′.

According to block 710, a determination is made of the retail price of hardware plus optimal expected profit for services net of effort cost, p′. As discussed more fully below in the section Example Model, this step includes model elements of:

p′=p+r′a′−v(a′).

According to block 720, a determination is made of the retailer's expected revenue R(Q, ν) as a function of retailer order quantity Q and retailer effort parameter ν. As discussed more fully below in the section Example Model, this step includes model elements of:

R(Q,ν)=(p′−s)Emin(Q, D_{ν})+sQ.

According to block 730, a determination is made of the total expected supply chain profits π_{c}(Q,v) as a function of retailer order quantity Q and retailer effort parameter ν. As discussed more fully below in the section Example Model, this step includes model elements of:

π_{c}(Q,ν)=−k(ν)−cQ+R(Q, ν).

According to block 740, a determination is made of ν(Q), the smallest effort level that maximizes supply chain profits π_{c}(Q,ν) for any fixed Q. As discussed more fully below in the section Example Model, this step includes model elements of:

ν(Q) is the smallest solution to k′(ν)=δR(Q, ν)/δv.

According to block 750, a determination is made of k(ν(Q)), the cost of the effort level ν(Q). As discussed more fully below in the section Example Model, this step includes model elements of:

The effort cost function k(ν) is given. Evaluate it at ν=ν(Q).

According to block 760, the wholesale price for the service is set to be Ws=Cs. A determination is made of the wholesale price schedule W(Q). As discussed more fully below in the section Example Model, this step includes model elements of:

w(Q)=γc+(1−γ)[R(Q,ν(Q))−k(ν(Q))]/Q.

An Example Model

A discussion is now directed to more fully explaining a calculation and analysis of the terms and conditions for the sale of products and ancillary services between the supplier and retailer as discussed in block 300 of FIG. 3. These calculations and analysis are performed in whole or in part in the particular machines shown in FIGS. 6B and 8.

As used herein and in the claims, the term “supply chain” is system of organizations or firms involved in moving products and services from a supplier to a customer.

For nomenclature, a supply chain with one supplier is referred as “he” and one retailer is referred as “she.” Both the supplier and retailer are risk-neutral. An assumption is made that both the product (also referred to herein as hardware) and the service are provided by a single supplier. Let w be the wholesale price, p the retail price, c the unit cost, and s the salvage value for the basic product. Let wₛ be the wholesale price, pₛ the retail price and cₛ the unit cost for the ancillary service. Initially assume that 0<c<w<p, s<c, 0<cₛ and 0≦r=pₛ−wₛ≦pₛ−cₛ=r′. Further, assume that s, c, p, cₛ, pₛ are exogenous and that w and wₛ are selected by the supplier within the specified ranges. As discussed below, one example embodiment allows the retailer to control retail prices of the product and service. Here, the coordinating mechanisms obtained under exogenous retail prices extend to the case in which the retail prices are endogenous.

The retailer faces random demand for hardware D_{ν} with cumulative distribution F(x|ν)=P(D_{ν}≦x) where ν is a parameter, such as the mean demand, that can be influenced by the retailer's effort. D_{ν} is stochastically increasing in ν if F⁻(x″ν)=1−F(x|ν) is increasing in ν. As an example, consider F(x|ν)=P(νθ+ε≦x) where θ and ε are random variables. The special case where θ is a positive constant reduces to the additive case. In this case mean of D_{ν} is an affine function of ν, namely νθ+E[ε], and the variance of D_{ν} is unaffected by ν. The special case where ε is a constant reduces to the multiplicative case. In this case, ν influences the variance but not the mean when θ is mean zero and influences both the mean and the variance otherwise. The cost of hardware sales effort, k(ν), ν≧ν₀>0 is assumed to be an increasing convex function with k(ν₀)=0, e.g. k(ν)=(ν−ν₀)² defined on ν≧ν₀. Retailers can influence demand by merchandizing, doing point-of-sale advertising, providing attractive shelf space and guiding consumer purchases with sales personnel.

If the retailer orders Q units and exerts effort k(v), his sales will be min(Q, D_{ν}). Each unit of hardware sold represents an opportunity to attach a service. To build a model of the cost of attaching services to the sales of hardware, assume the effort has to be made on each individual unit of hardware sold. The effort influences the proportion a ∈ (0,1) of hardware sales that result in attached services through an increasing convex function v(a),a≧a₀ with v(a)=0 for a≦a₀, so the total expected cost of attaching services of 100a % to the hardware is v(a)min(Q, D_{ν}).

An assumption is made that v(a) increases sufficiently fast over the interval [a₀, 1] so that the equation v′(a)=r has a root a(r)<1 for all r>v′(a₀). An alternative assumption that leads to a similar model is when the sales effort is made on each hardware sale and each sale is for an average of more than one unit as assumed above. If the average sale is for q units of hardware and attaching services to these units requires effort v(a) then the average cost per unit is v(a)/q. By setting v(a)←v(a)/q the model reduces to the case where q=1. An assumption is made that the cost of effort functions a(v) and k(ν) are public information. As discussed below, the supplier can estimate these functions.

The retailer's profit function is given by the following:

$$\begin{matrix}{π}_{R} ( Q , v , a \vert w , r ) = - k ( v ) - wQ + ( p + ra - v ( a ) ) \\ Emin ( Q , {D}_{v} ) + {sE ( Q - {D}_{v} )}^{+} \\ = - k ( v ) - ( w - s ) Q + ( p + ra - v ( a ) - s ) \\ Emin ( Q , {D}_{v} ) .\end{matrix}$$

The expected profit for the supplier is given by the following:

π_{S}(Q,ν,a|w,r)=(w−c)Q+(r′−r)a Emin(Q, D_{ν}).

The expected profit for a coordinated supply chain is given by the following:

π_{C}(Q,ν,a)=π_{R}(Q, ν,a|c,r′).

We will now explore conditions on D_{ν} that guarantee the joint concavity of Emin(Q, D_{ν}) and therefore the joint concavity of π_{R}(Q,ν,a|w,r) in Q and ν for fixed a under the mild additional assumption that p+ra−v(a)>s. The condition on D_{ν} is concavity over a common probability space. More precisely, a common probability space exists on the following:

αD_{ν1}+(1−α)D_{ν2}≦D_{αν1+(1-α)ν2}, ∀α∈[0,1], ν1, ν2>0,

which is equivalent to an assumption on stochastic concavity of D_{ν} in ν.

Assumption 1. D_{ν} is stochastically concave and increasing in ν.

This assumption holds, for example, when D_{ν}=h(ν)θ+ε, h(ν) is concave and increasing in ν and θ is a non-negative random variable. This follows because in the common probability space we generate θ and ε first and then D_{νi}=h(νᵢ)θ+ε, i=1, 2 and on this common probability space condition holds on account of the concavity of h(ν) and the fact that θ is positive. We will retain Assumption 1 throughout the discussion.

Proposition 1. π_{R}(Q,ν,a|w,r) is jointly concave in Q and ν and π_{C}(Q,a):=min_{ν} π_{C}(Q, ν, a) is concave in Q for all a such that p+ra−v(a)>s.

The proof of Proposition 1 uses the following two lemmas:

Lemma 1. If f(x, y),x, y ∈ R is jointly concave in x and y, non-decreasing in y, and y(ν),ν ∈ R is concave in ν, then f(x, y(ν)) is jointly concave in x and ν.

Proof. Suppose α∈ [0,1]. For any x₁, x₂, ν₁, ν₂ ∈ R, we have αy(ν1)+(1−α)y(ν2)≦y(αν₁+(1−α) ν₂) by the concavity of y(ν). Further by the joint concavity and monotonicity of f(x, y),

αf(x₁, y(ν₁))+(1−α) f(x₂, y(ν₂))≦f(αx₁+(1−α) f(x₂), αy(ν₁)+(1−α)y(ν₂))≦f(αx₁+(1−α) f(x₂), y(αν₁+(1−α) ν₂))

Lemma 2. Emin(Q, D_{ν}) is jointly concave in Q and ν.

Proof. Since D_{ν} is concave in v and min(Q, D) is jointly concave in Q and D and increasing in D, then min(Q, D_{ν}) is jointly concave in Q and v by a direct application of Lemma 1. More precisely, αmin(Q, D_{ν1})+(1−α)min(Q, D_{ν2})≦min(Q, D_{αν1+(1-α)ν2}) α∈ [0,1].

Since concavity is preserved by taking expectations it follows that Emin(Q, D_{ν}) is jointly concave in Q and ν.

The desired result is now proved.

Proof of Proposition 1. If p+ra−v(a)>s then (p+ra−v(a)−s)Emin(Q, D_{ν}) is jointly concave in Q and ν. Subtracting the linear term (c−s)Q and the convex term k(ν) preserves the joint concavity so π_{R}(Q, ν,a|w,r) is jointly concave. The concavity of π_{C}(Q, a) follows from a projection theorem.

Retailer's Problem and Comparative Statics

In a decentralized setting, independent of the order quantity Q, it is optimal for the retailer to select a=a(r), the solution to the first order condition v′(a)=r. Due to the joint concavity, the retailer's optimal order quantity Q_{R}(w, r) and sales effort ν_{R}(w, r) satisfy the following first order conditions:

F(Q|ν)=[p−w+r a(r)−v(a(r))]/[p−s+r a(r)−v(a(r))]

k′(ν)=(p+r a(r)−v(a(r))−s) [δEmin(Q, D_{ν})/δν].

The optimal attach rate for a coordinated supply chain is to select a(r′), the root of v′(a)=r′. The optimal order quantity Q_{C} and optimal sales effort level ν_{C} for a coordinated supply chain are given by Q_{C}=Q_{R}(c, r′) and ν_{C}=ν_{R}(c, r′). Also, let Q₀=Q_{R}(w, 0) and ν₀=ν_{R}(w, 0) and notice that these are respectively the optimal order quantity and optimal effort for the basic product when the ancillary service is not offered. Q₀ and ν₀ are also the optimal decisions when the service is offered but the retailer has no stake in the sales of services and as a result does not exert costly effort in selling the service.

The following results describe the behavior of Q_{R} and ν_{R} as a function of w and r.

Proposition 2. Q_{R}(w, r) and ν_{R}(w, r) are decreasing in w ∈ [c, p] and increasing in r ∈ [0, r′]. Moreover, Q₀<Q_{R}(w, r)<Q_{C}, ν₀<ν_{R}(w, r)<ν_{C} for all w ∈ (c, p), r ∈ (0, r′). (4) In order to prove Proposition 2, the following lemma is established:

Lemma 3. Emin(Q, D_{ν}) has increasing differences in (Q, ν). Moreover, π_{R}(Q,ν,a|w,r) has increasing differences in (Q, ν) for all a such that p+ra−v(a)>s. Finally, π_{R}(Q,ν,a|w,r) has increasing differences in (Q, a) and (ν, a) for all a ∈ [a₀, a(r)], where a(r) is the root of the equation v′(a)=r.

Proof. Since ∂Emin(Q, D_{ν})∂Q=F⁻(Q|ν) is increasing in ν on account of D_{ν} being stochastically increasing, it follows that Emin(Q, D_{ν}) has increasing differences in (Q, ν). Subtracting individual terms in Q and ν preserves the property of increasing differences so π_{R}(Q, ν,a|w, r) also has increasing differences in (Q, ν) for any a such that p+ra−v(a)>s. Moreover, if r≧v′(a), ∂π_{R}(Q, ν,a|w,r)/∂a=(r−v′(a))Emin(Q, D_{ν}) is increasing in Q and ν. Thus π_{R}(Q, ν,a|w,r) has increasing differences in(Q, a) and (ν, a) for a ∈ [a₀, a(r)].

The monotonicity of Q_{R} and ν_{R} in w and r is now proved.

Proof of Proposition 2. ∂π_{R}(Q, ν,a|w, r)∂Q, ∂π_{R} (Q, ν,a|w, r)/∂v and ∂π_{R}(Q, ν,a|w,r)/∂a are decreasing in w and increasing in r. By Lemma 3, π_{R} (Q, ν,a|w,r) has increasing differences in (Q, ν, a). Then by the comparative statics of increasing differences, the interior solutions to the concave optimization problem have the monotone properties. The inequality follows directly from the monotonicity of Q_{R} and ν_{R} and the definitions of the boundary points Q₀, Q_{C} and ν₀, ν_{C}.

The first inequality in Proposition 2 shows that adding an ancillary service motivates the retailer to place a larger order for the basic product and this is because the underage cost for the basic product is larger in the presence of the ancillary service. The second inequality shows that the retailer's optimal order quantity is below the optimal order size in a coordinated supply chain with the same being true for the exerted effort. The short fall in the order quantity and effort has to do with double marginalization of the basic product.

In practice, the effort cost functions v(a) and k(ν) may not be known by the supplier. However, if they are known to the retailer, then the supplier can estimate these functions through a series of experiments with wholesale prices. Given any constant wholesale price scheme (w, r), w ∈ (c, p), r ∈ (0, r′), the supplier can interpret the retailer's order quantity Q(w, r) as the best-response function Q_{R}(w, r). Suppose the supplier wants to fit the effort cost functions into quadratic form, e.g., v(a)=0.5A(a−a₀)² defined on a≧a₀ and k(ν)=0.5B(ν−ν₀)² defined on ν≧ν₀. There are four parameters A, a₀, B, ν₀ the supplier will estimate. Note that both v(a) and k(ν) are strictly increasing thus Q_{R}(w, r) is strictly decreasing in w and strictly increasing in r. Hence four different pairs of (w, r) and their corresponding Q(w, r) plugged into the equation set (2)-(3) are sufficient for the supplier to estimate the unknown parameters in the quadratic form. If the form of effort cost function is unknown, multiple pairs of correspondence between (w, r) and of Q(w, r) can be used to interpolate the cost curves with more data points ensuring a more accurate estimation.

Supply Chain Coordination: Price Schedules and Target Rebates

This section presents a wholesale price schedule that coordinates the supply chain. Recall that π_{C}(Q, ν, a)=π_{R}(Q, ν,a|c, r′). In such a coordinated supply chain, the decision maker would select a=a(r′), the root of the equation v′(a)=r. Let p′=p+r′a′−v(a′) be the retail price of the hardware plus the optimal expected profit for services net of the cost of effort. The coordinated supply chain expected profit reduces to the following:

π_{C}(Q, ν)=−k(ν)−cQ+R(Q, ν)

where

R(Q, ν)=p′Emin(Q,D_{ν})+sE(Q−D_{ν})⁺=(p−s)Emin(Q, D_{ν})+sQ.

Let ν(Q) be the smallest effort that maximizes π_{C}(Q, ν) for any fixed Q. Then ν(Q) is the smallest solution to k′(ν)=R₂(Q, ν) where R₂ is the partial derivative of R(Q, ν) with respect to ν and

π_{C}(Q)=π_{C}(Q, ν(Q))=−k(ν(Q))−cQ+R(Q, ν(Q)).

From Proposition 1, π_{C}(Q) is concave. Moreover, Q_{C}=Q_{R}(c, r′) maximizes π_{C}(Q). Let π_{C}=π_{C}(Q_{C}).

Theorem 1. The schedule r=r′ and

w(Q)=γc+(1−γ)[R(Q, ν(Q))−k(ν(Q))]/Q

coordinates the supply chain giving 100 γ % of the chain profits to the retailer and 100(1−γ) % of the profits to the supplier, for 0≦γ≦1.

Proof. With r=r′ the retailer faces the same optimization problem as the supply chain in terms of a, so he selects a=a(r′). The retailer's remaining problem is as follows:

π_{R}(Q, ν)=−k(ν)−wQ+R(Q, ν).

It is optimal for him to select effort v(Q) to maximize −k(v)+R(Q, ν), so his remaining problem is:

π_{R}(Q)=−k(ν(Q))−wQ+R(Q, ν(Q)).

Faced with a wholesale price schedule w(Q) the retailer's function becomes γπ_{C}(Q) so he will select an order quantity that maximizes the profit of the coordinated supply chain, with γπ_{C} going to the retailer and(1−γ)π_{C} to the supplier. w(Q|r) is written to emphasize the dependence of the wholesale price schedule that coordinates the supply chain given the gross margin r′ for the service. Here, w(Q|r′) is increasing in r′ so the wholesale price schedule for the hardware is higher the higher the gross margin for the ancillary service. In particular, the wholesale price schedule for the basic product is higher than it would be in the absence of services.

Since the coordinated solution dominates the uncoordinated solution, bounds are placed on γ so that both the supplier and the retailer are better off than they would be with a constant wholesale price. Notice that although the schedule gives all the profits of selling services to the retailer, by selling him services at cost cₛ, the wholesale price schedule w(Q) is higher than it would be in the absence of sales of services. In fact, the wholesale price is higher by (1−γ)(r′a′−v(a′))Emin(Q, D_{ν}(Q))/Q≃(1−γ)r′a′, an increase which represents a (1−γ) fraction of the coordinated supply chain's optimal expected service profit.

Implementation of Wholesale Price Schedule

As stated the wholesale price schedule in Theorem 1 may be subject to restraints and to arbitrage opportunities in the case of multiple retailers. There are several ways of mitigating these problems. One could argue that the wholesale price schedule takes into account the cost of effort of the retailer and thereby it is justified to have a different wholesale price schedules for different retailers. The arbitrage problem is often solved by designing retailer-specific stock keeping units which makes it easier for the supplier to identify units diverted to other retailers. In addition to these problems, the supplier may want to find mechanisms that work within existing contracts. For example, if prior to engaging in channel coordination efforts there is a contract with constant wholesale prices for the basic product and the service then the issue is how to implement the wholesale price schedule of Theorem 1 on top of existing constant wholesale prices. This section provides ways to implement this.

The first is in terms of a rebate schedule and the second is based on a target rebate with a target on the order quantity. The rebates are based on the retailer's order quantity and not on sales which are more difficult to observe and monitor and second; rebate programs do not require buy backs. Moreover, the implementation through target rebates may help coordinate the supplier's basic product and ancillary service departments.

This section also considers an implementation mechanism that allows the supplier to charge different wholesale prices for the basic product and the product bundled with the service, where both of these prices are associated with the total volume of the basic product ordered by the retailer.

Rebate Schedule

Suppose that prior to engaging in channel coordination efforts, the supplier uses fixed wholesale prices for both the hardware and service. For example, the supplier may be using the wholesale prices w ∈ (c, p) and r ∈ (0, r′) that maximize his expected profits in the absence of channel coordination. If the supplier's department in charge of implementing a mechanism to coordinate the supply chain cannot modify the current wholesale prices below the current sales quantities, then he can implement a rebate mechanism as described here.

Assuming the retailer is rational, he will select service effort a(r)<a(r′), where a(r) is the root of v′(a)=r, and will select his optimal order quantity is Q_{R}=Q_{R}(w, r)<Q_{R}(c, r′)=Q_{C} and his optimal hardware effort is ν_{R}=ν_{R}(w, r)<ν_{R}(c, r′)=ν_{C}. The following rebate mechanism on sales and efforts that go beyond the status quo coordinates the supply chain as explained in the next proposition.

Proposition 3. The service rebate schedule

r(a)=(r′a−ra(r))/(a−a(r))

on expected attach rate a≧a(r) and the hardware rebate schedule

τ(Q)=[(w−w(Q))Q]/[Q−Q_{R}]

on units Q≧Q_{R} coordinate the supply chain.

Proof. Consider first the rebate schedule on service effort. To maximize the profit of services the retailer will select a≧a(r) to maximize

ra(r)+r(a)(a−a(r))−v(a)=r′a−v(a)

resulting in a′=a(r′). It is optimal for the retailer to select ν(Q) for any order quantity Q. Given the rebate schedule for hardware the retailer's problem is given by the following:

Max _{Q≧QR}[R(Q, ν(Q))−k(ν(Q))−(w−τ(Q)) (Q−Q_{R})−wQ_{R}]

Now (w−τ(Q))(Q−Q_{R})+wQ_{R}=w(Q)Q, so the retailer's objective reduces to

Min _{Q≧Qw}[R(Q, ν(Q))−k(ν(Q))−w(Q)Q]

This objective is equal to γπ_{C}(Q), so the retailer is induced to select an order quantity to coordinate the supply chain.

Target Rebate

The supplier does not need to offer the retailer a rebate schedule for service and order quantity. It is enough to give them two fixed target rebates of r(a′) per percentage of attach rate and τ(Q_{C}) per unit of hardware order quantity beyond service rate threshold a(r) and order quantity threshold Q_{R}. The two target rebates can be run independently but meeting both targets is incentive compatible for the retailer. The retailer needs to decide between effort a(r) that leads to a net margin ra(r)−v(a(r)) on each unit of hardware sold, or effort a(r′) that leads to a net margin r′a(r′)−v(a(r′)) per unit of hardware sold. Since the latter is larger than the former he will go for it and align the service effort with the supply chain. Second, consider his choice for the order quantity. Since he gets an extra τ(Q_{C}) for additional sales, if he declines the offer he gets

R(Q_{R}, ν(Q_{R}))−k(ν(Q_{R}))−wQ_{R}.

If he accepts it then he gets

R(Q_{C}, ν(Q_{C}))−k(ν(Q_{C}))−w(Q_{C})Q_{C}=γπ_{C}.

Then, as long as γ is large enough to improve the retailer's profits, he will prefer to move.

We briefly discuss another target rebate. It consists of three parameters T=(tₕ, rₛ, rₕ), where tₕ is the target for hardware order quantity and rₛ and rₕ are respective the service and hardware rebates. Meeting the threshold tₕ triggers both rebates. Note that for the hardware product, the target rebate is on the order quantity rendering the advantage of not requiring further buy-back coordination. The mapping with any tₕ ∈ [0,Q_{C}], rₛ=r′−r and rₕ=w−c works as a coordinating scheme. By varying the target tₕ, the supplier can arbitrarily allocate the profits of service and hardware with the retailer. It can be an efficient scheme for negotiation since it has only one parameter tₕ both parties need to agree on.

To be incentive compatible comparing to the decentralized case, the threshold tₕ is greater than Q_{R} for the interest of the supplier. Therefore this scheme is an incremental one, as is the other target rebate proposed in this paper, since it respects the existent wholesale price schedule (w, r) up to current levels Q(w, r) and a(r). One caveat becomes relevant if the target rebate program is done without consulting the hardware department of the supplier. Based on the wholesale prices (w, r), the hardware supplier expects sales Q(w, r) but the program will result in sales Q_{C}>Q(w, r), so the program may backfire if the hardware department is not prepared for increased sales. Note, however, that this problem is shared by the coordination mechanism that results in higher order quantities.

Service Premium

A different way to modify the implementation is to charge different prices for hardware sold with or without the service. The way Theorem 1 is stated w(Q) should be charged on every unit of hardware ordered. The retailer may not understand why he needs to pay a premium on all products. An alternative is to set r=r′ and to have a base price wₙ(Q) that is charged for all products and a premium p_{y}(Q) charged on the products sold with service. Then the following occurs:

wₙ(Q)=w(Q)−(1−γ)((pₛ−cₛ)a′v(a′))Emin(Q, D_{ν}(Q))/Q

and

p_{y}(Q)=(1−γ)((pₛ−cₛ)−v(a′)/a′)Emin(Q, Dᵥ(Q))/Q

achieve a similar purpose as the wholesale price schedule w (Q). To see this notice that the retailer will still select a’ and his expected ordering cost is [wₙ(Q)+a′p_{y}(Q))]=w(Q)Q, which would lead him to select effort v(Q_{C}) and order size Q_{C}.

Additive Demand Model

Discussion now turns to the additive demand model where D_{ν}=ν+ε and ε is a mean zero random variable with bounded support so that D_{ν} is non-negative. Let F(y|ν):=P(D_{ν}≦y). Then

δE min(Q, D_{ν})/δν=F(Q|ν)

This follows because Emin(Q, D_{ν})=∫₀^{Q}F⁻(y|ν)dy where F(y|ν)=P(ν+ε≦y)=G(y−ν) so taking derivatives with respect to ν under the integral results in

∂Emin(Q, D_{ν})/∂ν=∫₀^{Q}g(y−ν)dy=G(Q−ν)=F(Q|ν).

Suppose r=r′, then for a given Q, an optimal effort to sell the basic product can be found by solving the equation R₂(Q, ν)=k′(ν). This is equivalent to solving the following:

(p′−s)F(Q|ν)=k′(ν),

since R(Q, ν)=(p′−s)Emin(Q,D_{ν})+sQ.

Assume that ε is uniform [−Δ, Δ] and that the effort cost function is k(ν)=0.5B(ν−ν₀)². Then for Q values in the interval [ν−Δ, ν+Δ] the first order condition is given by

(p′−s)(Q+Δ−ν)/2Δ=B(ν−ν₀)⁺.

This equation has a unique solution in v only for values of Q≧ν₀−Δ. Since the demand is at least this large, this is not a practical restriction as it will be optimal to select Q at least this large. For values of Q in the interval [ν₀−Δ, ν₀+βΔ], the solution is given by the following:

ν(Q)=ν₀+α(Q+Δ−ν₀)

where α=(p′−s)/(p′−s+2ΔB) and β=(1+α)/(1−α).

To maximize R(Q, ν(Q))−cQ−k(ν(Q))=(p′−s)Emin(Q, D_{ν}(Q))−(c−s)Q−k(ν(Q)) over this interval, we first investigate the derivative with respect to Q for values of Q in the interval [ν₀−Δ, ν₀+βΔ]. Since

E min(Q, ν(Q)+ε)=αQ+E min((1−α)Q, ν₀+α(Δ−ν₀)+ε)

the derivative of R(Q, ν(Q)) with respect to Q is given by

α+(1−α)Pr(ε≧(1−α)(Q−ν₀)−αΔ)=α+(1−α²)/2−(1−α)²(Q−ν₀)/2Δ

The derivatives of the other two terms are simply −(c−s) and −α²B(Q+Δ−ν₀), so the total derivative is decreasing in Q guaranteeing that the function is concave. Setting the derivative equal to zero and solving for Q, the following is obtained:

Q_{c}=ν₀+[β−2φ/α(1−α)]Δ

where

φ=(c−s)/(p′−s+2 ΔB)<(p′−s)/(p′−s+2 ΔB)=α.

This gives an interior solution Q_{C} ∈ (ν₀−Δ, ν₀+βδ) since Q_{C} is within the bounds whenever φ∈ (0, α) but it is already known that φ<α, and φ>0 whenever s<c.

### NUMERICAL EXAMPLE

An example embodiment is now applied to the case c=1000, p=1150, s=950, r′=100, a₀=0.2. Assume that the effort cost for attaching sales is v(a)=0.5A(a−a₀)², a ∈ [a₀,1] where A=400, a₀=0.20. Then a′ is the solution to 400(a−a₀)=100, or equivalently a′=0.45 and v(a′)=200(0.25)²=12.50. Let p′=p+r′a′−v(a′)=1150+45−12.50=1182.50.

Let the cost of effort be of the form k(ν)=0.5B(ν−ν₀)², ν₀=500, then for Δ=100 and B=(p′−s)/2Δ=1.1625 we have α=½, β=3, φ=0.1075 so Q_{C}=714, ν_{C}=ν(Q_{C})=657 and net expected profit π_{C}=$101,651.

This same solution and profit can be obtained by using the wholesale price schedule in Theorem 1. Namely, r=r′ and

w(Q)=γc+(1−γ)[(p′−s)Emin(Q, ν₀+α(Q+Δ−ν₀))+sQ−0.5Bα²(Q+Δ−ν₀)²]/Q

In contrast, an uncoordinated supply chain would use a constant wholesale price for both the hardware and the attached rate. Suppose that r=40 and w=1100. Then the retailer will select effort a=0.30 and will then select Q and ν to maximize the following:

(p̂−s)Emin(Q,D_{ν})−(w−s)Q−0.5B(ν−ν₀)²

where p̂=p+ra−v(a).

Optimizing over ν results in

v̂(Q)=ν₀+α̂(Q+Δ−ν₀)≧ν₀

and optimizing over Q results in

Q_{R}=ν₀+[β̂−2φ̂/α̂(1−α̂)]Δ

where

φ̂=(w−s)/(p̂−s+2 ΔB)

α̂=(p̂−s)/(p̂−s+2 ΔB)

β̂=(1+α̂)/(1−α̂)

This yields Q_{R}=509 and ν_{R}=ν̂(Q_{R})=552, retailer's expected profit $27,263, OEM's expected profit $59,914 and total expected profit $87,177 which is 14% lower than the coordinated solution. The retailer will be better off with the coordinated solution for any γ≧0.2682 while the OEM will be better off with any γ≦0.4106. Thus, any γ∈ (0.2682, 0.4106) results in a win-win solution. For example, for γ=0.30 the retailer's profit would increase from $27,263 to $30,495 and the OEM's from $59,914 to $71,155.

Consider now the wholesale schedule r=r′, that charges w=1100 for the first 509 units and offers rebate

τ(Q)=(1100−w(Q))Q/(Q−509)

on each unit Q>509. As shown in Proposition 3, this rebate schedule coordinates the supply chain and is win-win for any γ in the interval (0.2682, 0.4106).

In an uncoordinated supply chain with constant wholesale prices the expected profit for the supplier is given by

$$\begin{matrix}{π}_{s} ( w , r ) = ( w - c ) {Q}_{R} + ( {r}^{′} - r ) a ( r ) Emin ( {Q}_{R} , {D}_{{v}^{⋀} ( QR )} ) \\ = ( w - c ) {Q}_{R} + ( {r}^{′} - r ) a [ {Q}_{R} - {( {Q}_{R} - {v}^{⋀} ( {Q}_{R} ) + Δ )}^{2} / 4 Δ ] \\ = - {( 1 - {α}^{⋀} )}^{2} {F ( {Q}_{R} )}^{2} / 4 Δ + \\ [ ( w - c ) + F - ( 1 - {α}^{⋀} ) DF / 2 Δ ] {Q}_{R} - {D}^{2} F / 4 Δ\end{matrix}$$

where F:=(r′−r)a(r), D:=Δ+ν₀−α̂(Δ−ν₀) and a=a₀+r/A. Note that ∂QR/∂w=−2Δ/C, where C:=(p̂−s+2ΔB) α″(1−α̂). We can verify that for any fixed service margin r≧0, πₛ(w, r) is strictly concave in w≦s+C(1+β̂)/2, where the upper bound on the wholesale price comes from the incentive-compatible constraint ν̂(Q)≧ν₀. Thus, the first order condition gives us the optimal wholesale price for the supplier in the uncoordinated chain as

w*=min{[((1−α̂)²F+C)(ν₀+(β̂+2s/C)Δ)−2Δ(F−c)+(1−α̂)DF]/2Δ[2+(1−α̂)²F/C], s+C(1+β̂)/2}

Retailer Owned Services

Discussion now turns to what happens when the supplier sells only the basic product and the retailer sells the product and later introduces her own ancillary service. First, consider the case where the initial relationship between the supplier and the retailer is governed by a constant wholesale price w ∈ (c, p). A discussion then focuses on a situation where there is initially a wholesale prices schedule that coordinates the supply chain for the sale of the basic product only, with a given profit sharing parameter γ.

Existing Constant Wholesale Price

For the constant wholesale price w ∈ (c, p), the order quantity and effort in the scenario without ancillary services are solutions to the first order conditions (2) and (3) with r=0. The solution is denoted as Q_{R}(w, 0) and ν_{R}(w, 0) to emphasize the dependence of the procurement quantity and the effort on both w and p. By way of example, w=1100 and p=1150 so Q_{R}(w, 0)=493, ν_{R}(w, 0)=543 resulting in retailer's profit $22,325 and OEM's profit $49,300.

Now suppose the retailer introduces a service and her net price per unit sold increases from p to the following:

p′=p+r′a(r′)−v(a(r′))>p.

To be more precise, suppose that the unit cost of service is cₛ and the unit selling price is pₛ for a unit profit r′=pₛ−cₛ. This unit profit elicits an effort a(r′) so that the net revenue per unit of hardware sold is p′. For the data provided above, r′=$100, p′=$1,182.50 and Q_{R}(w, r′)=542, ν_{R}(w, r′)=571 with retailer's profit $38,855 and OEM's profit $54,200. Notice that the improvement in profits is respectively 74% and10% so the supplier benefits substantially from the introduction of services by the retailer. The improvement of 10% for the supplier on selling the basic product comes completely from the increase in the retailer's procurement quantity from 493 to 542 units.

Let π_{D}(w,r′|r′) be the total decentralized supply chain profit when the wholesale price for the basic product is w and the retailer owns the service earning gross margin r′ per unit sold excluding the cost of effort. For the example, we have π_{D}(w,r′|r′)=$93,055. Let π_{D}(w,r|r′) be the total decentralized supply chain profit when the wholesale price for the basic product is w, the supplier owns the service, the gross margin for the service is r′ and the retailer gets r ∈ (0,r′). For the running example of r=40, we have π_{D}(w,r|r′)=$87,177. The difference is not a coincidence as attested by the following result.

Theorem 2. For 0≦r<r′, the following occurs:

π_{D}(w,r′|r′)>π_{D}(w,r|r′).

Proof. The uncoordinated supply chain profits when the retailer owns the service are given by the following:

π_{D}(w,r′|r′)=(p′−s)Emin(Q_{R}(w, r′), D_{νR}(w, r′))−(c−s)Q_{R}(w, r′)−k(ν_{R}(w, r′)).

In contrast, the uncoordinated supply chain profits when the supplier owns the service are given by:

π_{D}(w,r|r′)=(p̂−s)Emin(Q_{R}(w, r′), D_{νR}(w, r))−(c−s)Q_{R}(w, r)−k(ν_{R}(w, r))

where p̂=p+r′a(r)−v(a(r))<p′. Notice that the net profit per unit is lower with the supplier owned service due to the double marginalization of the service which also results in less effort a(r)<a(r′). Moreover, since Q_{R}(w, r)<Q_{R}(w, r′) and ν_{R}(w, r)<ν_{R}(w, r′), the order quantity and the sales of the basic product are also lower and as a result π_{D}(w,r|r′)<π_{D}(w, r′|r′).

With no coordination, the supply chain has higher efficiency when the retailer owns the service than when the supplier owns it. The reason is that when the retailer owns the service, she has incentive to carry a larger order quantity for the basic product thus alleviating the double marginalization for the hardware. In addition, since she fully captures the margins on the service, there is no double marginalization problem for the ancillary service.

To coordinate the supply chain the supplier may propose a wholesale price schedule to coordinate the channel and distribute the gains from coordination. The resulting wholesale price schedule is given by:

w(Q|c,r′)=γc+(1−γ)[R(Q(c,r′))−k(ν(c,r′))]/Q

which is the same form as the wholesale price schedule of Theorem 1 that applies when the supplier owns the ancillary service. What differs is the range of values of γ over which the wholesale price schedule is win-win. In the example, when the retailer owns the ancillary service, the range of values that lead to a win-win solution is γ ∈ (0.3822, 0.4668) in contrast to γ ∈ (0.2682, 0.4106) which is the win-win range when the supplier owns the service. Since γ represents the retailer's share it is clear that the retailer is in a stronger position when he owns the service. The choice of γ=0.40, for example, improves the retailer's profits from $38,855 to $40,660 and the OEM's profit from $54,200 to $60,990.

This is a solution in which the retailer owns the service and is better for both the retailer and the supplier relative to the uncoordinated solution where the supplier owns the service. Indeed, the expected profits under that case are, respectively, $27,263 and $59,914. This illustrates that sometimes the disadvantage to the supplier of not owning the service may be offset by a combination of the larger order quantity that prevails when the retailer introduces the service and the design of a win-win wholesale price schedule that coordinates the supply chain.

Table 1 (shown below) summarizes the profits for both parties under different scenarios.

TABLE 1

| Scenario | Π_{R} | Π_{S} | Π_{C} |
|---|---|---|---|
| Without ancillary service | $22,325 | $49,300 | $71,625 |
| Service provided by the retailer | $38,855 | $54,200 | $93,055 |
| Service provided by the supplier | $27,263 | $59,914 | $87,177 |
| Coordinated supply chain (γ = 0.40) | $40,660 | $60,990 | $101,650 |

In many situations, one would expect one of the supply chain members to have a cost advantage in terms of providing the ancillary service. In the case of extended warranties, the supplier can enjoy a cost advantage if he either manufactures the parts or if he has access to them at lower prices. In this case, total supply chain profits will be higher if the supplier provides the service in conjunction with the wholesale price schedule w (Q) and r=r′ as in Theorem 1.

As an example, suppose that the unit cost of providing the service is $10 higher for the retailer and so his gross margin is r′=90 instead of r′=100. Then, in a coordinated supply chain will have total expected profit equal to $98,805. In the uncoordinated chain, with the retailer owning the services, she would make $36,551 while the supplier will make $53,600, so the range of win-win sharing parameters is (0.3699, 0.4575). If γ=0.40 is used the retailer gets $39,522 which is less than the $40,660 she would get if the supplier owned the service.

Existing Wholesale Price Discount Schedule

Suppose now there is already a wholesale price schedule w (Q|c, r′=0) prior to retailer's service introduction that increases the combined profit of selling per unit of hardware from p to p′=p+r′a(r′)−v(a(r′)), where r′ is the net profit of the retailer service. The retailer will then take advantage of the existing wholesale price schedule and place a larger order quantity enjoying most of the benefits of introducing the ancillary service.

To see this more formally, let C(Q|r′):=max_{ν≧ν0}{−k(ν)+R(Q, ν)} and π_{R}(r′, w (Q)):=max_{Q}{−w(Q)Q+C(Q|r′)} denote the optimal profit of the retailer under any net revenue r′ per unit of the service product and any wholesale price schedule w (Q). In particular, π_{c}(r′):=π_{R}(r′,c) is the total profit of the centralized supply chain who faces the marginal cost c per unit of hardware. The following result shows that with the existing wholesale price schedule unchanged, the retailer gains proportionally more than the supplier without further coordination after introducing retailer owned services. Theorem 3. For any r′>0,

π_{R}(r′, w (Q|c,0))>γπ_{C}(r′)>γπ_{C}(0)=π_{R}(0, w (Q|c,0)),

where

w (Q|c, 0)=γc+(1−γ)C(Q|0)/Q, 0<γ<1

is the existing coordination wholesale price schedule before the service introduction.

Proof. Realizing R(Q, ν)=p′Emin(Q, D_{ν})−sE(Q−D_{ν})⁺ is strictly increasing in p′ for any Q and ν, we have p′=p+r′a(r′)−v(a(r′))>p leading to C(Q|r′)>C(Q|0) for r′>0. Then

π_{R}(r′, w (Q|c,0))=max_{Q}{−γcQ−(1−γ)C(Q|0)+C(Q|r′)}

>max_{Q}{−γcQ−(1−γ)C(Q|0)+C(Q|0)}

=γπ_{C}(0)=π_{R}(0, w (Q|c,0)).

Here, the last equality is due to the definition of the coordinated wholesale price schedule.

This result illustrates the risk of offering a wholesale price schedule that does not have an upper bound. It can be partially fixed by offering the wholesale price schedule w (Q|c, 0) only up to Q_{C}(c, r′). The upper bound on the order quantity is needed because having no such restrictions the retailer can attach services resulting in higher hardware order quantities at discounted prices and not benefiting the supplier who designed the wholesale price schedule without considering ancillary services. The target rebate schedule that drops the wholesale price to wₕ=cₕ beyond the target threshold is even more dangerous but can also be partially remedied by placing an upper bound Q≦Q_{C}(c, r′) on the order quantity with rebates.

Endogenous Retail Prices

In this section, an assumption is made that demand for both the basic product and the ancillary service are price sensitive and that the retailer sets both the price p of the basic product and the price pₛ of the ancillary service. Let D_{ν}(p) be the demand for the basic product under sales effort ν. Assume that D_{ν}(p) is strictly stochastically decreasing in p and lim _{p→∞}pE[D_{ν}(p)]=0 (i.e., expected revenues decrease to zero as the price increases to infinity).

Recall the attach rate to measure the service sales effort in the basic model of exogenous retail prices. For the case of endogenous retail prices, the service sales effort cost function is generalized to a function v(a, pₛ) of service sales effort a and ancillary service retail price pₛ. We will assume that v(a, pₛ) is a strictly increasing function of pₛ given any attach rate a. In other words, charging a higher retail price pₛ for the ancillary service results in a higher cost to maintain the same attach rate.

The retailer's profit function is given by the following:

π_{R}(Q, ν,p,pₛ,a|w,wₛ)=−k(ν)−(w−s)Q+[p−s+(pₛ−wₛ)a−v(a, pₛ)]Emin(Q, D_{ν}(p)),

where retail prices p and pₛ are decision variables in addition to order quantity Q, the sales efforts v and a.

Let π_{C}(Q, ν, p, pₛ, a)=π_{R}(Q, ν, p, pₛ, a|w=c, wₛ=cₛ) be the expected profit of a coordinated supply chain. This function is optimized with respect to the five variables under consideration. Start with the decisions related to a and pₛ. Clearly a and pₛ should be selected to maximize (pₛ−cₛ)a−v(a,pₛ). The first order conditions are pₛ−cₛ=v₁(a,pₛ) and a=(a,pₛ) where v₁ and v₂ are the partial derivatives of v(a,p) with respect to a and p, respectively. Assume that the first order conditions have a unique solution (a*, pₛ*) and that this solution represents a global optimizer with respect to a and pₛ. A sufficient condition for this is that v is increasingly convex in (a, p) and that the mixed partial derivative v₁₂ ∈ (0,1) for all (a, p). For example, the function v(a, p)=0.5p(a−a₀)² satisfies these properties.

The coordinated supply chain expected profit reduces to the following:

π_{C}(Q, ν, p)=−k(ν)−cQ+R(Q, ν, p)

where

R(Q, ν, p)=(p−s+(pₛ*−cₛ*)a*−ν(a*,pₛ*))Emin(Q, D_{ν}(p))+sQ.

Let ν(Q, p) be the smallest effort that maximizes π_{c}(Q, p, ν) for any fixed p and Q. Then ν(Q, p) is the smallest solution to k′(ν)=R₂(Q, ν, p) where R₂ is the partial derivative of R with respect to ν. By the similar logic demonstrated in Theorem 1, we have the following nonlinear wholesale price schedule, which can be viewed as a combination of the nonlinear wholesale price quantity discount schedule and the nonlinear price-discount sharing (PDS) scheme. Note that the wholesale price schedule is often implemented as a rebate so the actual retail price p posted by the retailer that is needed in the following contract to compute the rebate amount can be correctly verified.

Corollary 1. The schedule wₛ=cₛ and

w(Q|p)=γc+(1−γ)[R(Q, ν(Q,p),p)−k(ν(Q,p))]/Q

coordinates the supply chain giving 100γ % of the chain profits to the retailer and 100(1−γ) % of the profits to the supplier, for 0≦γ≦1.

Furthermore, suppose the maximum of the optimization problem max_{p,ν}π_{C}(Q, ν, p) for any fixed Q exists and let us denote the maximizers by p (Q) and ν (Q). Similar to Theorem1, the following nonlinear wholesale price schedule results.

Corollary 2. The schedule wₛ=cₛ and

w(Q)=γc+(1−γ)[R(Q, ν (Q),p (Q))−k(ν (Q))]/Q

coordinates the supply chain giving 100γ % of the chain profits to the retailer and 100(1−γ) % of the profits to the supplier, for 0≦γ≦1.

Conclusion

Post sales services are a significant revenue opportunity. Support services generate a revenue stream over the lifetime of the original product. In many sectors, the service business contributes as much or more revenue and profit margin than the initial product sale. Aftermarket services also benefit revenues indirectly, by extending the useful life of the installed base and thereby ensuring steady sales of consumables for those products.

In view of the huge opportunities in the service sector, example embodiments relate to a coordinating mechanism for a supplier selling a basic product and an ancillary service through a retailer. The mechanism can achieve a win-win situation for both the supplier and the retailer, and increase the supplier's service attach rates. The coordination scheme calls for giving up all the supplier's profits for the service and getting the money back (i.e., recoups the lost profit of the post-sale service) by increasing the wholesale price of the hardware. This contract with an appropriate sharing mechanism can be a barrier to entry for the retailer to enter the market with its own ancillary service.

The mechanism can be implemented by charging a higher price for products with the attached service. It can also be implemented by using a target rebate schedule starting from arbitrary wholesale prices for the product and the service provided the retailer's decisions in terms of efforts and order quantity are consistent with the terms of the prevailing contract. In such an embodiment, it can be implemented by the service department as long as the hardware department is not capacity constrained.

Example embodiments also include a situation where the retailer provides the ancillary service, and in an uncoordinated setting this leads to higher supply chain profits assuming the retailer has the same cost structure for services as the supplier. Moreover, the wholesale price schedule that coordinates the supply chain and the total supply chain profits are the same regardless of who owns the service. One difference is in the range of profit sharing parameters that lead to mutual gains.

Example embodiments also include a mechanism to estimate the effort cost functions for hardware and services and further include a channel that coordinates wholesale price schedules in the context of endogenous retail prices for the basic product and the service.

FIG. 8 is a block diagram of a computer system 800 in accordance with an example embodiment of the present invention. The computer system executes methods described herein, including one more of the blocks illustrated in FIGS. 3-5 and 7.

The computer system includes one or more databases or warehouses 860 coupled to one or more computers or servers 805.

By way of example, the computer 805 includes memory 810, algorithms 820 (such as algorithms to execute methods discussed herein), a module to determine wholesale price scheduled 825, display 830, processing unit 840, and one or more buses 850. The processor unit includes a processor (such as a central processing unit, CPU, microprocessor, application-specific integrated circuit (ASIC), etc.) for controlling the overall operation of memory 810 (such as random access memory (RAM) for temporary data storage, read only memory (ROM) for permanent data storage, and firmware). The processing unit 840 communicates with memory 810, algorithms 820, and module 825 via one or more buses 850 and performs operations and tasks necessary for calculating and analyzing product and service terms as explained herein and determining a wholesale price schedule. The memory 810, for example, stores applications, data, programs, modules and algorithms (including software to implement or assist in implementing embodiments in accordance with the present invention) and other data.

Data 870 is input to the computer 805, such as data used to build a model of expected profits of supply chain members (shown in FIG. 5) or data used to determine wholesale price schedules (shown in FIG. 6A). The computer 805 provides output 880, such as channel contract parameters.

In one example embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with example embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit the invention.

In some example embodiments, the methods illustrated herein and data and instructions associated therewith are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the various embodiments in accordance with the present invention, embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
determining, for a sale of a product and a post-sale service for the product from a supplier to a retailer, an expected supply chain profit for the sale as a function of an effort cost function of the retailer, a quantity of the product ordered, and an expected revenue of the retailer; and
determining a wholesale price schedule that is a function of the quantity of the product ordered by the retailer, wherein the wholesale price schedule reduces effects of double marginalization on the sale of the product and the post-sale service.

2) The method of claim 1, wherein the expected revenue of retailer R(Q, ν) is given by:
R(Q, ν)=(p′−s)Emin(Q, D_{ν})+sQ,
wherein Q is the quantity of the product ordered by the retailer, ν is a sales effort for the product exerted by the retailer, p′ is a retail price of the product plus an expected profit for the post-sale services minus cost of sales effort for services, D_{ν} is a demand for the product, and s is a salvage value for the product.

3) The method of claim 1, wherein the expected supply chain profit π_{c} (Q, v) is given by:
π_{c} (Q, ν)=−k(ν)−cQ+R(Q, ν),
wherein Q is the quantity of the product ordered, ν is a sales effort for the product exerted by the retailer, k(ν) is a cost of product sales effort ν, c is a unit cost of the product to the supplier, and R(Q, ν) is the expected revenue of the retailer.

4) The method of claim 1 wherein the wholesale price schedule w(Q) is given by:
w(Q)=γc+(1−γ)[R(Q,ν(Q))−k(ν(Q))]/Q,
wherein γ is a fraction of the expected supply chain profits given to the retailer, c is a unit cost of the product to the supplier, Q is the quantity of the product ordered by the retailer, k(ν(Q)) is a cost of effort exerted by the retailer to sell Q, and R(Q, ν(Q)) is the expected revenue of the retailer. 5) The method of claim 1 further comprising, determining a retail price of the product plus an optimal expected profit for the post-sale service net of effort cost p′ which is given by:
p′=p+r′a′−v(a′),
wherein p is the retail price of the product, a′ is a level of effort made by the retailer to attach services, r′ is a total margin earned on each unit of services by the supplier and retailer, ν(a′) is a cost of attach effort a′ incurred by the retailer to sell the product.

6) The method of claim 1, wherein the supplier sells the post-sale service to the retailer at cost leaving profit from a sale of the post-sale service to the retailer.

7) The method of claim 1, wherein the wholesale price schedule includes prices that decrease with increased order quantity by the retailer of the product.

8) A method executed by a computer to build a model of expected profits of a retailer and a supplier in a supply chain, the method comprising:
calculating, for a product and an ancillary service sold to the retailer by the supplier, expected profits of the retailer and the supplier as a function of a quantity of the product ordered by the retailer, product sales effort by the retailer, and an effort parameter of the retailer; and
building the model of the expected profits of the supply chain as a function of the quantity of the product ordered by the retailer, the product sales effort by the retailer, and the effort parameter of the retailer.

9) The method of claim 8, wherein the expected profits of a coordinated supply chain π_{c} (Q, ν, a) are given by:
π_{c} (Q, ν, a)=π_{R} (Q, ν, a|c, r′),
wherein Q is a quantity of the product ordered by the retailer, ν is the product sales effort by the retailer, a is the effort parameter of the retailer, c is a unit cost of the product to the supplier, and r′ is a total margin earned on each unit of services by the supplier and the retailer.

10) The method of claim 8, wherein expected profits of the supplier πₛ (Q, ν, a|w, r) are given by:
πₛ (Q, ν, a|w, r)=(w−c)Q+(r′−r)aEmin(Q, D_{ν}),
wherein Q is a quantity of the product ordered by the retailer, ν is the product sales effort by the retailer, a is the effort parameter of the retailer, c is a unit cost of the product to the supplier, r′ is a total margin earned on each unit of services by the supplier and the retailer, and w is a wholesale price of the product.

11) The method of claim 8, wherein expected profits of the retailer π_{R} (Q, σ, a|w, r) are given by:
π_{R} (Q, ν, a|w, r)=−k(ν)−(w−s)Q+(p+ra−v(a)−s)Emin(Q, D_{ν}),
wherein Q is the quantity of the product ordered by the retailer, ν is the product sales effort by the retailer, a is the effort parameter of the retailer, D_{ν} is a demand for the product, and s is a salvage value for the product, k(ν) is an effort exerted by the retailer, r is a margin earned by the retailer on the ancillary service, and w is a wholesale price of the product.

12) The method of claim 8, the model of expected profits shares profits between the retailer and the supplier from the sale of the product to reduce double marginalization on the sale of both the product and the ancillary service.

13) A method executed by a computer, comprising
calculating costs for attaching a post-sale service to a product when a supplier provides the product to a retailer and sells the post-sale service to the retailer for no profit leaving profit from a sale of the post-sale service to the retailer; and
generating, from the costs, a wholesale price schedule of prices to sell the product to the retailer to reduce effects of double marginalization on a sale of the product and the post-sale service.

14) The method of claim 13 further comprising, determining the wholesale price schedule with the prices that decrease with increase order quantity by the retailer of the product.

15) The method of claim 13, wherein the supplier chooses what fractions of a supply chain profit are received by the supplier and by the retailer.

16) The method of claim 13 further comprising, computing prices at which to sell the product from the supplier to the retailer given that the supplier performs the post-sale service for a customer who purchases both the product and the post-sale service from the retailer.

17) The method of claim 13, wherein the supplier sells the post-sale service to the retailer for no profit but recoups lost profit on sale of the post-sale service by increasing wholesale prices for the product sold to the retailer.

18) The method of claim 13, wherein the wholesale price schedule provides wholesale prices for the product to the retailer such that some profit from a sale of the post-sale service are given to the retailer and the wholesale prices are higher than prices in absence of the retailer selling the post-sale service.

19) The method of claim 13, wherein the wholesale price schedule has an upper bound to limit an amount of the product the retailer is allowed to order from the supplier.

20) The method of claim 13, wherein the retailer controls a sales effort and retail sale prices for selling both the product and the post-sale service when the supplier provides the post-sales service to a customer who purchases the product.
